(19) United States
(12) Patent Application Publication
(10) Pub. No.: US 2025/0011637 A1
(43) Pub. Date: Jan. 9, 2025

(54) ETHYLENE VINYL ACETATE-BASED DISPERSIONS SUITABLE AS POUR POINT DEPRESSANTS WITH IMPROVED PERFORMANCE AND STABILITY

(71) Applicant: Evonik Operations GmbH, Essen (DE)

(72) Inventors: Sofia SIRAK, Plymouth Meeting, PA (US); Alisa BORGER, Darmstadt (DE); Jasmin MEURER, Harxheim (DE); Claudia Meister, Darmstadt (DE); Gaël MOSNIER, Biblis (DE); Johannes RIEGER, Reinheim (DE); Ines BERWING, Groß-Umstadt (DE); Marie-Christin WINKLER, Mörlenbach (DE)

(73) Assignee: Evonik Operations GmbH, Essen (DE)

(21) Appl. No.: 18/710,325

(22) PCT Filed: Nov. 10, 2022
(86) PCT No.: PCT/EP2022/081432

§ 371 Date: May 15, 2024

(30) Foreign Application Priority Data
Nov. 15, 2021 (EP) 21208234.1

(51) Int. Cl. C09K 8/524

(52) U.S. Cl. CPC C09K 8/524

(57) ABSTRACT

The invention relates to new ethylene vinyl acetate-based polymer dispersions with increased stability compared to state-of-the-art and to a preparation process thereof. The invention also relates to a method for inhibiting wax deposition and reducing the pour point, viscosity and yield stress of crude oils by treating the crude oils with these stable ethylene vinyl acetate-based polymer dispersions.

### TECHNICAL FIELD OF THE INVENTION

The invention relates to new ethylene vinyl acetate-based polymer dispersions with increased stability compared to state-of-the-art and to a preparation process thereof. The invention also relates to a method for inhibiting wax deposition and reducing the pour point, viscosity and yield stress of crude oils by treating the crude oils with these stable ethylene vinyl acetate-based polymer dispersions.

### BACKGROUND OF THE INVENTION

Crude oils may contain varying amounts of paraffins, the quantity of which depend on the crude oils' geographical origin. At the high temperatures prevailing within oil wells, the paraffins are liquid and dissolved in the oil. During extraction, transportation and further processing of the oil, however, the temperature decreases, leading to crystallization of the paraffins. This results in an increased viscosity of the crude oil and paraffin deposition on pipelines making transportation and storage of the crude oil more difficult and expensive. Further, paraffin crystals may clog processing equipment such as filters and pipelines, thus increasing servicing costs. The amount of wax and other components in the crude oil also contribute to the crude oil's pour point or lowest temperature at which the crude oil will still flow. Crude oils with pour points above standard operating and storage temperature lead to great difficulty processing and transporting the crude oil as the crude oil may solidify.

Therefore, there is a need for modifying the crystallization of paraffins in crude oil such that the paraffins in the crude oil do not interfere with crude oil transport, processing, and storage. It is known that polymeric additives can influence paraffin crystallization. Such additives are also referred to as paraffin inhibitors or pour point depressants.

Pour point depressants (PPDs) are designed to modify paraffin crystallization in a way to lower the lowest temperature at which an oil can still flow or pour, i.e. lower the crude oil's pour point. Pour point depressants based on polyalkyl (meth)acrylates, dialkyl maleic acid copolymers as well as ethylene vinyl acetate copolymers (EVA) are well known. EVA-based polymers are well established in the oil and gas industry but are difficult to handle since they are typically solid and need to be diluted in solvents such as toluene or xylene at very low concentrations in the range of 5-15%.

In order to increase the amount of active polymer concentration and improve handling of EVA-based products, dispersions can be prepared that will deliver a liquid product with low viscosity. However, the major drawback of these dispersions is that the stability over time can be poor. These products are typically not used immediately and need to be transported to the location of end-use, so a long product shelf-life is extremely important. If these dispersions become unstable, it is extremely difficult and costly to try to reprocess the product at an additive injection site. If the dispersion becomes too unstable, the material may not even be usable and will need to be discarded. Furthermore, unstable dispersions with phase separation or solid dropout can clog customer equipment for additive injection.

DE3905681A1 describes a mixture of a higher and lower molecular weight graft polymers consisting of an EVA base grafted with alkyl acrylates having a C₁₈ to C₂₂ alkyl chain. The combination of two different grafts is compared to mixtures of graft polymers with a polyalkyl acrylate. These polymer mixtures are not dispersions or emulsions, are not easy to handle, and need to be diluted in a solvent.

US2017/0029732A1 discloses the compositions of ethylene vinyl acetate copolymers for use as PPDs for crude oils. This composition includes at least 2 different EVA types where the content of vinyl acetate between these two EVA types differs at least by 5 wt %. The EVAs are dissolved in a solvent at very low concentration, 1-10 wt %.

U.S. Pat. No. 20,170,009067A1 describes a process for making pour point depressants for crude oils. The PPD is made from free radical polymerization of alkyl methacrylates in the presence of ethylene vinyl acetate polymers. The polymers are dissolved in an organic solvent.

U.S. Pat. No. 4,906,682 describes a method for preparing dispersions of EVA copolymers in two organic solvents. The dispersions are stabilized by an alkyl methacrylate-based graft polymer. The emulsions are said to be stable at room temperature for 6 months, which is a relatively short time with very stable temperature conditions. This type of stability would not be suitable for large scale production with shipment and storage in regions with a wide range in temperature conditions.

Therefore, there is still the need to provide a stable ethylene vinyl acetate-based dispersion with excellent long-term stability and improved pour point depressant performance.

### BRIEF SUMMARY OF THE INVENTION

After thorough investigation, the inventors of the present invention have surprisingly found that the EVA-based dispersion as defined in claim 1 solves the above technical problem as it delivers improved pour point depressant performance with a much more stable product in comparison to state-of-the art products.

Therefore, in a first aspect, the invention relates to an EVA-based dispersion as defined in claim 1 and its dependent claims.

A second aspect of the invention is a method for preparing the EVA-based dispersions of the present invention.

A third aspect of the invention is directed to a method for inhibiting wax deposition and reducing pour point, viscosity and yield stress of a crude oil by adding a dispersion as defined in the present invention to the crude oil to form a crude oil composition.

A fourth aspect of the invention corresponds to a crude oil composition comprising a crude oil and an EVA-based dispersion as defined in the present invention.

### DETAILED DESCRIPTION OF THE INVENTION

### EVA-Based Dispersion According to the Invention

Thus, the present invention relates to a dispersion comprising
A) at least one graft copolymer A),
   wherein the graft copolymer A) is obtainable by grafting onto an ethylene-based copolymer having a weight-average molecular weight of 20,000 to 150,000 g/mol and consisting of 60 to 70% by weight of ethylene and 30 to 40% by weight of vinyl acetate, based on the total weight of the ethylene-based copolymer,
   a composition comprising the following monomers a):
   a1) alkyl (meth)acrylates of general formula (I)

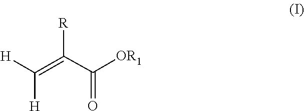

wherein
R is H or CH₃ and
R₁ is a linear or branched, saturated or unsaturated alkyl group with 1 to 30 carbon atoms,
and
a2) hydroxy esters of general formula (II)

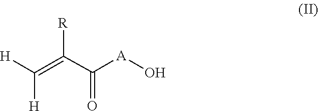

wherein
R is H or CH₃ and
A is a branched or unbranched, aliphatic C₁ to C₄ carbon-based group
B) at least one ethylene-based copolymer B) obtainable by polymerizing a monomer composition consisting of
   b1) 55% to 85% by weight of ethylene, and
   b2) 15% to 45% by weight of vinyl acetate, based on the total weight of ethylene-based copolymer B),
and
C) a carrier medium.

The inventors of the present invention have found that the specific combination of an EVA graft polymer A), which comprises an amount of more than 30% by weight of vinyl acetate and has a weight average molecular weight of 20,000 to 150,000 g/mol, together with an ethylene-vinyl acetate copolymer B) leads to very stable EVA dispersions. Indeed, the inventors have observed that the Dv50 value of the droplets in the dispersions according to the present invention are below 8 μm, which is much lower than the Dv50 value of the droplets to be found in the state-of-the-art EVA dispersions. Since the droplets of the dispersion are smaller, the dispersions according to the invention are much more stable products in comparison to state-of-the art products, while still maintaining excellent pour point depressant performance.

Preferably, the EVA dispersions according to the invention have Dv50 value of the droplets below 8 μm, preferably below 6 μm, after mixing all components of the dispersion as measured by microscope. In the present invention, the Dv50 value of the droplets in the dispersion were measured with a Malvern Morphologi G3 device. Particle counts and Dv50 values were calculated by the image analysis Morphologi software using a 2.5 mm analysis radius. The Dv50 value corresponds to the maximum particle diameter below which 50% of the sample volume exists—also known as the median particle size by volume.

According to the present invention, the dispersions are heterogeneous systems, and the dispersion can also be referred to as an emulsion or suspension.

Preferably, the dispersion of the invention comprises 5 to 20% by weight of component A), 10 to 40% by weight of component B) and 40 to 85% by weight of component C), based on the total weight of the dispersion. More preferably, the EVA-based dispersion comprises 5 to 15% by weight of component A), 20 to 40% by weight of component B) and 45 to 75% by weight of component C), based on the total weight of the dispersion. Most preferably, the EVA-based dispersion comprises 5 to 10% by weight of component A), 25 to 35% by weight of component B) and 55 to 70% by weight of component C), based on the total weight of the dispersion.

Preferably, the amounts of compounds A), B) and C) sum up to 95 to 100% by weight, based on the total weight of the dispersion.

In the present invention, the weight-average molecular weights (M_{w}) of the polymers are determined by gel permeation chromatography (GPC) using polymethylmethacrylate calibration standards using the following measurement conditions:

Eluent: tetrahydrofuran (THF)

Operation temperature: 35° C.

Columns: the column set consists of one precolumn PSS SDV 8×50 mm, two columns PSS-SDV LinL 8×300 mm, two columns PSS-SDV 100 Å 8×300 mm, all columns from the company PSS in Mainz, Germany and with an average particle size of 10 μm, and a last column KF-800D 8×100 mm (company Shodex)

Flow rate: 1 mL/min

Injected volume: 100 μL

Instrument: Agilent consisting of a Series 1260 autosampler, a Series 1100 pump and column oven Detection device: a refractive index detector from Agilent Series 1100

### EVA-Based Graft Copolymers A)

The graft copolymer A) according to the invention is obtainable by grafting monomers a) comprising alkyl (meth)acrylates a1) of general formula (I) and hydroxy esters a2) of general formula (II), onto an ethylene-based copolymer having a weight-average molecular weight of 20,000 to 150,000 g/mol and consisting of 60 to 70% by weight of ethylene and 30 to 40% by weight of a compound selected from the group consisting of vinyl acetate, based on the total weight of the ethylene-based copolymer. More preferably, the ethylene-based copolymer has a weight-average molecular weight of 20,000 to 150,000 g/mol and consists of 60 to 67% by weight of ethylene and 33 to 40% by weight of vinyl acetate, based on the total weight of the ethylene-based copolymer.

The ethylene-based copolymer, which corresponds to the base of the graft copolymers A) according to the invention, onto which the monomers a) are grafted, has a weight-average molecular weight (M_{w}) from 20,000 to 150,000 g/mol, preferably from 45,000 to 150,000 g/mol, more preferably from 60,000 to 150,000 g/mol, even more preferably from 70,000 to 150,000 g/mol.

Preferably, the polydispersity index (PDI) of the EVA-based graft copolymers A) according to the invention is in the range from 1 to 10.0, more preferably from 1.1 to 7, even more preferably from 1.1 to 5. The polydispersity index is defined as the ratio of weight-average molecular weight to number-average molecular weight (M_{w}/Mₙ).

The monomers a) of the EVA-based graft copolymers A) comprise at least alkyl (meth)acrylates a1) of general formula (I) and hydroxy esters a2) of general formula (II).

The EVA-based graft copolymers A) according to the invention are graft polymers. Preferably, the weight ratio of EVA graft base to the (meth)acrylate graft layer is in a range from 1:1 to 1:9, even more preferably 1:2 to 1:6. In other words, in the graft copolymer A), the weight ratio of monomers a) grafted onto the ethylene-based copolymer is in a range from 1:1 to 9:1, even more preferably 2:1 to 6:1.

According to a preferred embodiment of the invention, the monomers a) comprise from 60 to 99% by weight of monomers a1) and from 1 to 40% by weight of monomers a2), more preferably 65 to 85% by weight of monomers a1) and from 15 to 35% by weight of monomers a2), based on the total weight of monomers a).

Preferably, the amounts of monomers a1) and a2) sum up to 100% by weight, based on the total amount of monomers a).

### Monomers a1)

The alkyl (meth)acrylates a1) correspond to C₁ to C₃₀ alkyl (meth)acrylates, preferably to C₁ to C₆ alkyl (meth)acrylates, C₇ to C₁₂ alkyl (meth)acrylates or a mixture thereof.

The term “C₁ to C₃₀ alkyl (meth)acrylates” refers to esters of (meth)acrylic acid and linear or branched alcohols having 1 to 30 carbon atoms. The term encompasses individual (meth)acrylic esters with an alcohol of a particular length, and likewise a mixture of (meth)acrylic esters with alcohols of different lengths. Likewise, the term “C₁ to C₆ alkyl (meth)acrylates” or “C₇ to C₃₀ alkyl (meth)acrylates” refers to esters of (meth)acrylic acid with linear or branched alkyl chain having 1 to 6 carbon atoms or 7 to 30 carbon atoms, respectively. The term encompasses individual (meth)acrylic esters with an alcohol of a particular length, and likewise mixtures of (meth)acrylic esters with alcohols of different lengths.

Examples of the C₁ to C₆ alkyl (meth)acrylate monomers, where the linear or branched alkyl group contains from 1 to 6 carbon atoms, are methyl methacrylate (MMA), methyl and ethyl acrylate, propyl methacrylate, butyl methacrylate (BMA) and acrylate (BA), isobutyl methacrylate (IBMA), hexyl and cyclohexyl methacrylate, cyclohexyl acrylate and or a mixture thereof. Most preferred C₁ to C₆ alkyl (meth)acrylate monomer is methyl methacrylate, butyl methacrylate or a mixture thereof.

According to the invention, the C₇ to C₃₀ alkyl (meth)acrylate monomers may independently be selected from the group consisting of 2-ethylhexyl (meth)acrylate, heptyl (meth)acrylate, 2-tert-butylheptyl (meth)acrylate, n-octyl (meth)acrylate and 3-isopropylheptyl (meth)acrylate, nonyl (meth)acrylate, decyl (meth)acrylate, isodecyl (meth)acrylate, undecyl (meth)acrylate, 5-methylundecyl (meth)acrylate, n-dodecyl (meth)acrylate, 2-methyldodecyl (meth)acrylate, tridecyl (meth)acrylate, 5-methyltridecyl (meth)acrylate, n-tetradecyl (meth)acrylate, pentadecyl (meth)acrylate, oleyl (meth)acrylate, cycloalkyl (meth)acrylates, cyclohexyl (meth)acrylate having a ring substituent, tert-butylcyclohexyl (meth)acrylate, trimethylcyclohexyl (meth)acrylate, bornyl (meth)acrylate and isobornyl (meth)acrylate. Particularly preferred C₇ to C₃₀ alkyl (meth)acrylates are (meth)acrylic esters of a linear C₇ to C₁₂ alcohol mixture (C₇ to C₁₂ alkyl (meth)acrylate). Most preferred C₇-C₁₂ alkyl (meth)acrylate is 2-ethylhexyl (meth)acrylate, decyl (meth)acrylate, isodecyl (meth)acrylate or a mixture thereof.

According to a preferred embodiment, the alkyl (meth)acrylates a1) are selected from methyl methacrylate, butyl methacrylate, 2-ethylhexyl (meth)acrylate, decyl (meth)acrylate, isodecyl (meth)acrylate or a mixture thereof.

According to another preferred embodiment, the alkyl (meth)acrylates a1) correspond to 0 to 20% by weight of C₁ to C₆ alkyl (meth)acrylates and 80 to 100% by weight of C₇ to C₃₀ alkyl (meth)acrylates, based on the total weight of alkyl (meth)acrylates a1). More preferably, the alkyl (meth)acrylates a1) correspond to 0 to 20% by weight of C₁ to C₆ alkyl (meth)acrylates and 80 to 100% by weight of C₇ to C₁₂ alkyl (meth)acrylates, based on the total weight of alkyl (meth)acrylates a1). Even more preferably, the alkyl (meth)acrylates a1) correspond to 0 to 20% by weight of methyl methacrylate, butyl methacrylate or a mixture thereof, and 80 to 100% by weight of 2-ethylhexyl (meth)acrylate, decyl (meth)acrylate, isodecyl (meth)acrylate or a mixture thereof, more preferably isodecyl (meth)acrylate, based on the total weight of alkyl (meth)acrylates a1). Most preferred alkyl (meth)acrylates a1) is isodecyl (meth)acrylate.

### Monomers a2)

In the present invention, the monomers a2) are hydroxy esters of general formula (II), which correspond to hydroxyalkyl (meth)acrylate monomers, in which the substituted alkyl group is a C₂-6 alkyl, branched or unbranched carbon-base group. Among the hydroxyalkyl (meth)acrylate monomers a2) suitable for use in the present invention are 2-hydroxyethyl acrylate, 2-hydroxyethyl methacrylate (HEMA), 2-hydroxypropyl acrylate, 2-hydroxypropyl methacrylate, 1-methyl-2-hydroxyethyl acrylate, 1-methyl-2-hydroxyethyl methacrylate, 2-hydroxybutyl acrylate and 2-hydroxybutyl methacrylate. The preferred hydroxyalkyl (meth)acrylate monomers a2) are 2-hydroxyethyl methacrylate (HEMA), 1-methyl-2-hydroxyethyl methacrylate, 2-hydroxypropyl methacrylate or a mixture thereof. Most preferred hydroxyalkyl (meth)acrylate a2) is 2-hydroxyethyl methacrylate.

According to another preferred embodiment, the monomers a) consists of 60 to 99% by weight of monomers a1) and from 1 to 40% by weight of monomers a2), more preferably 65 to 85% by weight of monomers a1) and from 15 to 35% by weight of monomers a2), based on the total weight of monomers a), wherein the alkyl (meth)acrylates a1) correspond to 0 to 20% by weight of methyl methacrylate, butyl methacrylate or a mixture thereof, and 80 to 100% by weight of 2-ethylhexyl (meth)acrylate, decyl (meth)acrylate, isodecyl (meth)acrylate or a mixture thereof, more preferably isodecyl (meth)acrylate, based on the total weight of alkyl (meth)acrylates a1) and wherein the alkyl (meth)acrylates a2) is selected from the group consisting of 2-hydroxyethyl methacrylate (HEMA), 1-methyl-2-hydroxyethyl methacrylate, 2-hydroxypropyl methacrylate or a mixture thereof, more preferably is 2-hydroxyethyl methacrylate.

### Other Monomers a)

In another particularly preferred form of the invention, the monomers a) of the EVA-based graft copolymer A) may further comprise additional monomers a3), in addition to monomers a1) and a2).

Suitable monomers a3) include aminoalkyl (meth)acrylates and aminoalkyl (meth)acrylamides, nitriles of (meth)acrylic acid and other nitrogen-containing (meth)acrylates, aryl (meth)acrylates, carbonyl-containing (meth)acrylates, (meth)acrylates of ether alcohols, (meth)acrylates of halogenated alcohols, oxiranyl (meth)acrylate, phosphorus-, boron- and/or silicon-containing (meth)acrylates, sulfur-containing (meth)acrylates, heterocyclic (meth)acrylates, maleic acid and maleic acid derivatives, fumaric acid and fumaric acid derivatives such as, for example, mono- and diesters of fumaric acid, vinyl halides, vinyl esters, vinyl monomers containing aromatic groups, heterocyclic vinyl compounds, vinyl and isoprenyl ethers, methacrylic acid and acrylic acid.

Preferably, the amounts of monomers a1), a2) and a3) sum up to 100% by weight, based on the total amount of monomers a).

### Ethylene-Vinyl Acetate Copolymer B)

The ethylene-based copolymer B) of the dispersion according to the present invention is obtainable by polymerizing a monomer composition consisting of
b1) 55% to 85% by weight of ethylene, and
b2) 15% to 45% by weight of vinyl acetate,

based on the total weight of the monomer composition to prepare the ethylene-based copolymer B).

The architecture of the ethylene vinyl acetate copolymers is not critical for many applications and properties. Accordingly, the ester-comprising polymers may be random copolymers, gradient copolymers, block copolymers and/or graft copolymers, more preferably random copolymers.

Unless otherwise noted, the weight amounts of the monomers b) in the monomer composition of the at least one ethylene-based copolymer B) are given relative to the total amount of monomers b) used, namely, the total weight of the monomer composition to prepare the ethylene-based copolymer B).

Preferably, the ethylene-based copolymers B) according to the invention have a weight-average molecular weight (M_{w}) from 20,000 to 1,000,000 g/mol, preferably from 45,000 to 500,000 g/mol, more preferably from 60,000 to 300,000 g/mol, even more preferably from 70,000 to 200,000 g/mol.

### Carrier Medium C)

The solvents which may be used in accordance with the invention as the carrier medium C) should be inert and compatible with the intended use in crude oils. Carrier media which meet the conditions mentioned are, for example, esters, higher alcohols or polyfunctional ether-alcohols, or a mixture thereof. Generally, the molecules of esters and alcohols suitable for use as the carrier medium may contain more than 4 carbon atoms per molecule.

According to a preferred embodiment of the invention, the carrier medium C) is a mixture of isodecanol and diethylene glycol, preferably a mixture of from 55 to 75% by weight of isodecanol and from 25 to 45% by weight of diethylene glycol, based on the total weight of the carrier medium C).

### Other Additives D)

Preferably, the dispersion according to the invention may comprise further additives including scale inhibitors, corrosion inhibitors, oxygen scavengers, biocides, emulsion breakers, antifoam agents, drag reducing agents, hydrate inhibitors, paraffin dispersants, pour point depressants, asphaltene control agents, or a mixture thereof.

Preferably, the amounts of compounds A), B), C) and D) sum up to 95 to 100% by weight, preferably sum up to 100% by weight, based on the total weight of the dispersion.

Process for preparing the EVA-based dispersion of the invention

Another aspect of the present invention is a process for preparing the dispersion of the present invention as defined herein, wherein the process comprises the following steps:
i) providing a graft copolymer A),
ii) providing an ethylene-based copolymer B),
iii) mixing the graft copolymer A) with the ethylene-based copolymer B) in a carrier medium C).

Preferably, concerning step i) of the above-indicated process, the graft polymer A) is prepared by free-radical polymerization. Customary free-radical polymerization is described, inter alia, in Ullmann's Encyclopedia of Industrial Chemistry, Sixth Edition.

In general, a polymerization initiator and optionally a chain transfer agent are used for this purpose.

The polymerization can be conducted under standard pressure, reduced pressure or elevated pressure. The polymerization temperature is also uncritical. However, it is preferably in the range from −20 to 200° C., more preferably 50 to 150° C. and even more preferably 80 to 130° C.

The polymerization step may be performed with or without dilution in a carrier medium. If dilution is performed, then the amount of the monomer composition, namely, the total amount of monomers, relative to the total weight of the reaction mixture, is preferably 20 to 90% by weight, more preferably 40 to 80% by weight, most preferably 50 to 70% by weight.

Preferably, the carrier medium used for diluting the monomer mixture is the same as the carrier medium C) of the dispersion according to the present invention. More preferably, the carrier medium is a mixture of isodecanol and diethylene glycol. Most preferably, the carrier medium is a mixture of from 55 to 75% by weight of isodecanol and from 25 to 45% by weight of diethylene glycol, based on the total weight of the carrier medium.

Preferably, the polymerization is conducted in presence of a radical initiator.

Suitable radical initiators are, for example, azo initiators, such as azobis-isobutyronitrile (AIBN), 2,2′-azobis (2-methylbutyronitrile) (AMBN) and 1,1-azobiscyclohexanecarbonitrile, and peroxy compounds such as methyl ethyl ketone peroxide, acetylacetone peroxide, dilauryl peroxide, tert-butyl per-2-ethylhexanoate, ketone peroxide, tert-butyl peroctoate, methyl isobutyl ketone peroxide, cyclohexanone peroxide, dibenzoyl tert-butyl peroxide, peroxybenzoate, tert-butyl peroxyisopropylcarbonate, 2,5-bis (2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis (tert-butylperoxy) cyclohexane, 1,1-bis (tert-butylperoxy)-3,3,5-trimethylcyclohexane, cumyl hydroperoxide, tert-butyl hydroperoxide and bis (4-tert-butylcyclohexyl) peroxydicarbonate. Preferably, the radical initiator is selected from the group consisting of 2,2′-azobis (2-methylbutyronitrile), 2,2-bis (tert-butylperoxy) butane, tert-butylperoxy 2-ethylhexanoate, 1,1-di-tert-butylperoxy-3,3,5-trimethylcyclohexan, tert-butyl peroxybenzoate and tert-butylperoxy-3,5,5-trimethylhexanoat. Particularly preferred initiators are tert-butylperoxy 2-ethylhexanoate and 2,2-bis (tert-butylperoxy) butane.

Preferably, the total amount of radical initiator relative to the total weight of the monomer mixture is 0.01 to 5% by weight, more preferably 0.02 to 3% by weight, most preferably 0.05 to 2% by weight.

The total amount of radical initiator may be added in a single step or the radical initiator may be added in several steps over the course of the polymerization reaction. Preferably, the radical initiator is added in several steps. For example, a part of the radical initiator may be added to initiate radical polymerization and a second part of the radical initiator may be added 0.5 to 3.5 hours after the initial dosage.

Optionally, the polymerization step may also comprise the addition of a chain transfer agent. Suitable chain transfer agents are especially oil-soluble mercaptans, for example n-dodecyl mercaptan or 2-mercaptoethanol, or else chain transfer agents from the class of the terpenes, for example terpinolene.

It is also possible to divide the monomer composition into an initial part and a second part and to add a part of the radical initiator to the initial part only to start the polymerization reaction therein. Then, the second part of the radical initiator is added to the second part of the monomer composition which is then added over the course of 0.5 to 5 hours, preferably 1.5 to 4 hours, to the polymerization reaction mixture. After addition of the second monomer mixture, a third part of the radical initiator may be added to the polymerization reaction as described above.

Preferably, the total reaction time of the radical polymerization is 2 to 10 hours, more preferably 3 to 9 hours.

Concerning step ii), the ethylene vinyl acetate copolymers B) to be used in accordance with the invention can also be prepared by the free radical polymerization method mentioned above. Preferably, the ethylene vinyl acetate copolymers can be manufactured according to the method described in EP 406684 A, to which reference is made explicitly for the purposes of disclosure.

The step iii) of the above-defined process for preparing the EVA-based dispersion of the present invention corresponds to mixing the graft polymer A) with the ethylene-based copolymer B) in a carrier medium C).

Preferably step iii) is performed at a temperature between 20° C. and 120° C., more preferably between 40° C. and 100° C.

### Method for Inhibiting Wax Deposition and Reducing Pour Point of a Crude Oil According to the Invention

A further aspect of the invention is a method of inhibiting wax deposition and reducing pour point, viscosity and yield stress of a crude oil by adding a dispersion according to the present invention to the crude oil to form a crude oil composition.

By adding a dispersion according to the present invention to the crude oil, the yield stress of said crude oil can be reduced. Yield stress corresponds to the stress below which no flow occurs for a waxy crude oil.

Preferably, the method is used for reducing the pour point of a crude oil. In the present invention, the pour point measurements were conducted according to ASTM D5853.

### Crude Oil Composition of the Invention

Yet another aspect of the invention is a crude oil composition comprising a dispersion according to the invention and a crude oil.

Advantageously, the inventors of the present invention have found that crude oil compositions treated with the EVA dispersion according to the invention have excellent low temperature properties as shown below in the experimental part.

In a preferred embodiment of the invention, the amount of the EVA-based dispersion of the invention in the crude oil composition is 0.001 to 1% by weight, relative to the total weight of the crude oil composition.

### Experimental Part

The invention is further illustrated in detail hereinafter with reference to Inventive Examples and Comparative Examples, without any intention to limit the scope of the present invention.

### Abbreviations

C₁ AMA C₁-alkyl methacrylate (methyl methacrylate; MMA)

C₄ AMA C₄-alkyl methacrylate (n-butyl methacrylate; BMA)

C₁₀ AMA C₁₀ alkyl methacrylate (isodecyl methacrylate)

EVA 18-150 ethylene-vinyl acetate with 18 wt % vinyl acetate (VA) and a melt flow index of 150

EVA 28-025 ethylene-vinyl acetate with 28 wt % vinyl acetate (VA) and a melt flow index of 25

EVA 33-025 ethylene-vinyl acetate with 33 wt % vinyl acetate (VA) and a melt flow index of 25

EVA 40-028 ethylene-vinyl acetate with 40 wt % vinyl acetate (VA) and a melt flow index of 28

EVA 28-150 ethylene-vinyl acetate with 28 wt % vinyl acetate (VA) and a melt flow index of 150

EVA 33-400 ethylene-vinyl acetate with 33 wt % vinyl acetate (VA) and a melt flow index of 400

HEMA 2-hydroxethyl methacrylate

IDMA isodecyl methacrylate

Mₙ number-average molecular weight

M_{w} weight-average molecular weight

PDI polydispersity index, molecular weight distribution calculated via M_{w}/Mₙ

VA content vinyl acetate content

### Test Methods

The polymer weight-average molecular weights were measured by gel permeation chromatography (GPC) calibrated using poly (methyl methacrylate) standards as described above. Tetrahydrofuran (THF) is used as eluent.

The kinematic viscosities of the polymers were measured at 40° C. and 100° C. according to ASTM D445 with no deviations.

Particle counts were measured using a Malvern Morphologi G3 device. Particle counts and Dv50 values were calculated by the image analysis Morphologi software using a 2.5 mm analysis radius. The Dv50 value corresponds to the maximum particle diameter below which 50% of the sample volume exists—also known as the median particle size by volume.

Pour point (PP) of the dispersions was measured according to ASTM D5853.

The ethylene-vinyl acetate polymers listed in Table 1 below were used to prepare the examples.

TABLE 1
Ethylene-vinyl acetate polymers

| | VA | | | |
|---|---|---|---|---|
| | content | Melt Flow | M_{w} | Mₙ |
| EVA grade | [wt %] | Index | [kg/mol] | [kg/mol] |
| EVA 18-150 | 18 | 150 | 384 | 31.5 |
| EVA 28-025 | 28 | 25 | 193 | 44.5 |
| EVA 33-025 | 33 | 25 | 139 | 45.9 |
| EVA 40-028 | 40 | 28 | 124 | 41.1 |
| EVA 28-150 | 28 | 150 | 95 | 33.7 |
| EVA 33-400 | 33 | 400 | 79 | 27.3 |

### Synthesis of the Dispersion According to the Invention (Inventive Example 1):

### EVA-g-PAMA Polymer A1)

The first step is the synthesis of the EVA-g-PAMA emulsifier. 10 g EVA 33-400 were dissolved in 50 g of isodecanol at 100° C. The solution was cooled down to 90° C. and 6.67 g of a monomer mixture of 2-hydroxyethyl methacrylate (HEMA) and isodecyl methacrylate (IDMA) in a ratio of 1:3 and 0.21 g tert-butylper-2-ethylhexanoate were added to the heel. Immediately after addition, 33.3 g of the same monomer mixture containing 0.33 g tert-butylper-2-ethylhexanoate were fed into the reaction heel over 210 minutes. Two hours after the feed end, 0.08 g tert-butylper-2-ethylhexanoate were added to the reaction vessel and allowed to stir for one hour. At the end of the reaction, a turbid, viscous solution with a polymer concentration of 50 wt % was obtained.

### Dispersion According to the Invention

In a second step, the dispersion was created. 16.98 g of the EVA-g-PAMA polymer A1) were added to a mixing vessel, heated to 90° C., and stirred at 200 rpm. As carrier medium C) or solvent, 31.2 g of isodecanol and 21.4 g diethylene glycol were added to the mixing vessel. Finally, 30.4 g EVA 28-025 (polymer B) were charged to vessel and mixed for 5 hours. A milky, white, stable dispersion with a solid content of 38.8 wt % was obtained.

Synthesis of Inventive Dispersions (Ex. 2-7) and Comparative Dispersions (Comp. Exs C₈-C₁₆):

These examples were prepared in the same way as Inventive Example 1 except the reaction mixture was changed according to Table 2 below.

### Model Oil A:

Model oil A was created by mixing 14% Sigma Aldrich paraffin wax mp=43-95° C. into a PAO2 base oil. The pour point of this model oil is 31° C.

### Model Oil B:

Model oil B was created by mixing 14% Sigma Aldrich paraffin wax mp=43-95° C. and 7% Sigma Aldrich paraffin wax mp>65° C. into a PAO2 base oil. The pour point of this model oil is 41° C.

TABLE 2
Inventive dispersions according to the invention and comparative dispersions

| | | | | Inventive Examples | | | | | | | Comparative Examples | |
|---|---|---|---|---|---|---|---|---|---|---|---|---|
| | | Dispersion No. | | 1 | 2 | 3 | 4 | 5 | 6 | 7 | C8 | C9 |
| Component | EVA-g-PAMA | IDMA | [wt %] | 5.1 | 5.1 | 5.1 | 5.1 | 5.1 | 5.1 | 5.1 | 5.1 | 5.1 |
| mixture | | HEMA | [wt %] | 1.7 | 1.7 | 1.7 | 1.7 | 1.7 | 1.7 | 1.7 | 1.7 | 1.7 |
| | | EVA 18-150 | [wt %] | | | | | | | | 1.7 | 1.7 |
| | | EVA 28-025 | [wt %] | | | | | | | | | |
| | | EVA 40-028 | [wt %] | | | | | | 1.7 | | | |
| | | EVA 33-025 | [wt %] | | | | | | | 1.7 | | |
| | | EVA 28-150 | [wt %] | | | | | | | | | |
| | | EVA 33-400 | [wt %] | 1.7 | 1.7 | 1.7 | 1.7 | 1.7 | | | | |
| | EVA | EVA 28-025 | [wt %] | 30.4 | | | | | 30.4 | 30.4 | 30.4 | |
| | | EVA 33-025 | [wt %] | | | | 30.4 | 15.2 | | | | 30.4 |
| | | EVA 40-028 | [wt %] | | | | | | | | | |
| | | EVA 28-150 | [wt %] | | | 15.2 | | 15.2 | | | | |
| | | EVA 33-400 | [wt %] | | 30.4 | 15.2 | | | | | | |
| | Solvent | DEG | [wt %] | 21.4 | 21.4 | 21.4 | 21.4 | 21.4 | 21.4 | 21.4 | 21.4 | 21.4 |
| | | Isodecanol | [wt %] | 39.7 | 39.7 | 39.7 | 39.7 | 39.7 | 39.7 | 39.7 | 39.7 | 39.7 |

| | | | | | | | | | | |
|---|---|---|---|---|---|---|---|---|---|---|
| Stability Score | [points] | 260 | 220 | 200 | 210 | 220 | 240 | 200 | 80 | 60 |
| Particle size, Dv50 | [μM] | 5.3 | 4.8 | 5.5 | 4.4 | 4.9 | 4.8 | 5.9 | 10.2 | 12.0 |
| Viscosity at 40° C. | [cSt] | 628 | 975 | 681 | n.m. | 772 | 895 | 457 | 497 | n.m. |
| Viscosity at 100° C. | [cSt] | 715 | 456 | 411 | 2156 | 798 | 1309 | 387 | 551 | 1026 |
| Pour Point in Model Oil | [° C.] | 13 | 7 | −23 | 12 | 5 | 9 | 14 | 15 | 14 |
| A [untreated PP of 31° C.] | | | | | | | | | | |
| Δ PP in Model Oil A | [° C.] | 18 | 24 | 54 | 19 | 26 | 22 | 17 | 16 | 17 |
| Pour Point in Model Oil | [° C.] | 40 | 28 | 40 | 31 | 31 | 32 | 32 | 40 | 42 |
| B [untreated PP of 41° C.] | | | | | | | | | | |
| Δ PP in Model Oil B | [° C.] | 1 | 13 | 1 | 10 | 10 | 9 | 9 | 1 | −1 |

| | | | | Comparative Examples | | | | | | |
|---|---|---|---|---|---|---|---|---|---|---|
| | | Dispersion No. | | C10 | C11 | C12 | C13 | C14 | C15 | C16 |
| Component | EVA-g-PAMA | IDMA | [wt %] | 5.1 | 5.1 | 5.1 | 5.1 | 5.1 | 5.1 | 5.1 |
| mixture | | HEMA | [wt %] | 1.7 | 1.7 | 1.7 | 1.7 | 1.7 | 1.7 | 1.7 |
| | | EVA 18-150 | [wt %] | 1.7 | 1.7 | 1.7 | 1.7 | | | |
| | | EVA 28-025 | [wt %] | | | | | 1.7 | | |
| | | EVA 40-028 | [wt %] | | | | | | | |
| | | EVA 33-025 | [wt %] | | | | | | | |
| | | EVA 28-150 | [wt %] | | | | | | 1.7 | 1.7 |
| | | EVA 33-400 | [wt %] | | | | | | | |
| | EVA | EVA 28-025 | [wt %] | | | | | 30.4 | 30.4 | |
| | | EVA 33-025 | [wt %] | 15.2 | | | | | | |
| | | EVA 40-028 | [wt %] | | | | | | | |
| | | EVA 28-150 | [wt %] | 15.2 | 30.4 | | 15.2 | | | 30.4 |
| | | EVA 33-400 | [wt %] | | | 30.4 | 15.2 | | | |
| | Solvent | DEG | [wt %] | 21.4 | 21.4 | 21.4 | 21.4 | 21.4 | 21.4 | 21.4 |
| | | Isodecanol | [wt %] | 39.7 | 39.7 | 39.7 | 39.7 | 39.7 | 39.7 | 39.7 |

| | | | | | | | | |
|---|---|---|---|---|---|---|---|---|
| Stability Score | [points] | 80 | 0 | 0 | 0 | 100 | 180 | 140 |
| Particle size, Dv50 | [μM] | >20 | >20 | >20 | >20 | 6.4 | 5.6 | 6.9 |
| Viscosity at 40° C. | [cSt] | 539 | 462 | 838 | 596 | 417 | 548 | 541 |
| Viscosity at 100° C. | [cSt] | 530 | 333 | 408 | 410 | 406 | 550 | 6.9 |
| Pour Point in Model Oil | [° C.] | n.m. | n.m. | n.m. | n.m. | 13 | 13 | 8 |
| A [untreated PP of 31° C.] | | | | | | | | |
| Δ PP in Model Oil A | [° C.] | — | — | — | — | 18 | 18 | 23 |
| Pour Point in Model Oil | [° C.] | n.m. | n.m. | n.m. | n.m. | 40 | 39 | 40 |
| B [untreated PP of 41° C.] | | | | | | | | |
| Δ PP in Model Oil B | [° C.] | — | — | — | — | 1 | 2 | 1 |

n.m. means “not measured”

### Sample Testing

The stability of the dispersions was tested by using an accelerated aging method. This method is used to mimic the stability of the dispersion over a period of 12 months at storage conditions that could be observed during global transport of the product, which also includes elevated temperatures. The method is carried out by taking a 100 ml sample of the dispersion. The sample is stored for 24 hours at 60° C. in an airtight bottle. After 24 hours, the sample is allowed to cool down to ambient temperature. Once the sample has reached ambient temperature, the bottle is shaken to ensure homogeneity. 30 g of the sample is placed in a centrifuge tube and is centrifuged at 30° C. and 3900 rpm for 20 minutes. After 20 minutes, the sample is scored according to Table 3 below. The sample is then centrifuged for another 40 minutes at 3900 rpm and 30° C. The sample is scored again according to Table 3. The sample is then placed for a final time in the centrifuge for 60 min at 3900 rpm and 30° C. and scored one more time according to Table 3. The scores from the three rounds of centrifuge testing are added to provide the final Stability Score for the sample. Products with Stability Scores above 220 points are considered very stable. Products with Stability Scores above 180 points are considered moderately stable. Products with stability scores <180 points are considered not stable. Stability testing is stopped if a product receives less than 80 points in the first centrifuge round (see Table 3 below).

TABLE 3
Scoring table to calculate the Stability Scores

| Points | Feature |
|---|---|
| 100 | No changes |
| 90 | Thin film on top |
| 80 | Thick film on top |
| 60 | Flow after 1-2 sec |
| 40 | Flow after 2-5 sec |
| 20 | Flow after 5-10 sec |
| 0 | Flow after 10 sec |

Performance of the examples was tested by measuring the change in pour point of Model Oils A and B after addition of 1000 ppm of the dispersion product.

### Results Discussion

Inventive Examples 1-7 all show very good dispersion stability with stability scores of 200 points or greater. In contrast, Comparative Examples all show poor stability scores of 180 point or less.

Comparative Examples C₁₁-C₁₃ all use the EVA grade 18-150 in the EVA-g-PAMA portion of the product. The M_{w} of this EVA grade was measured at 384,000 g/mol, which exceeds the M_{w} limit as defined in the present invention. When submitted to the accelerated stability testing, all 3

Comparative Examples were unstable and received 0 points. Further testing was not conducted. Inventive Example 3 can be compared to Comparative Example 13. The products are prepared in the same way, except that the EVA type in the EVA-g-PAMA portion of the product is varied. Inventive Example 3 uses an EVA grade in the EVA-g-PAMA portion of the product that has a M_{w} of 79,000 g/mol. Inventive Example 3 shows a very stable and well-performing product.

Comparative Examples C₈-C₁₀ use the EVA grade 18-150 in the EVA-g-PAMA portion of the product. Again, the M_{w} of the EVA in the EVA-g-PAMA portion of the product is too high according to the present invention, with a M_{w} of 384,000 g/mol. Examples C₈-C₁₀ try to disperse different EVA grades compared to Examples C₁₁-C₁₃. These Examples C₈-C₁₀ showed slightly better, but still very poor stability with stability scores of 60-80 points. These products would not be stable for an extended period. Particle size Dv50 values are high at more than 10 μm for the three products.

Pour point testing was also completed on the three unstable comparative products C₈-C₁₀ and compared to their very stable counterparts. Performance of the Inventive Examples was found to be equal or better to that of the unstable counterparts. For example, Inventive Example 1 and Comparative Example 8 are prepared in the same way with the same composition, except that the EVA type in the EVA-g-PAMA portion of the product is different. Both products perform equally in Model Oil B and Inventive Example 1 outperforms Comparative Example 8 in Model Oil A. This shows that the Inventive Examples deliver improved performance with a much more stable product. A similar comparison can be made between Inventive Example 4 and Comparative Example 9. Not only is the Inventive Example much more stable, it outperforms the Comparative Example in Model Oil A by 2° C. and in Model B by 11° C.

Comparative Example C₁₄ uses an EVA grade that was measured to have a M_{w} of 193,000 g/mol, which is lower than the previous Examples, but still above the upper M_{w} range limit according to the present invention. The product showed poor stability with a stability score of only 100 points and particle size Dv50 values greater than 6 μm.

Comparative Examples C₁₅ and C₁₆ both use EVA grades in the EVA-g-PAMA portion of the product with measured weight-average molecular weights of 139,000 g/mol. This M_{w} value falls within the M_{w} range according to the present invention; however, the vinyl acetate content is only 28 wt % which is below the required vinyl acetate amount of more than 30 wt %. The resulting emulsions have particle size Dv50 values of 5.6 μm (Example C₁₅) and 6.9 (Example C₁₆) μm, which are Dv50 values closed to the dispersion according to the invention. However, when the two products were submitted to the accelerated aging stability test, Example C₁₅ showed low stability with a 180-points stability score and C₁₆ had even poorer stability with a score of 140 points. This demonstrates that Comparative Examples do not have stability over time, whereas the dispersions according to the invention all show very good dispersion stability with stability scores of 200 points or greater.

1. A dispersion comprising the following components:
A) at least one graft copolymer A),
wherein the graft copolymer A) is obtainable by grafting onto an ethylene-based copolymer having a weight-average molecular weight of 2,000 to 150,000 g/mol and consisting of 60 to 70% by weight of ethylene and 30 to 40% by weight of vinyl acetate, based on the total weight of the ethylene-based copolymer,
a composition of monomers a) comprising:
a1) alkyl (meth)acrylates of general formula (I) 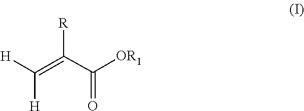
wherein
R is H or CH₃ and
R₁ is a linear or branched, saturated or unsaturated alkyl group with 1 to 30 carbon atoms,
and
a2) hydroxy esters of general formula (II) 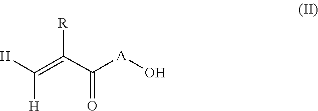
wherein
R is H or CH₃ and
A is a branched or unbranched, aliphatic C₁ to C₄ carbon-based group
B) at least one ethylene-based copolymer B) obtainable by polymerizing a monomer composition consisting of
b1) 55% to 85% by weight of ethylene, and
b2) 15% to 45% by weight of a vinyl acetate, based on the total weight of the ethylene-based copolymer B),
and
C) a carrier medium.

2. The dispersion according to claim 1, wherein the dispersion comprises 5 to 20% by weight of component A), 10 to 40% by weight of component B) and 40 to 85% by weight of component C), based on the total weight of the dispersion.

3. The dispersion according to claim 2, wherein the dispersion comprises 5 to 15% by weight of component A), 20 to 40% by weight of component B) and 45 to 75% by weight of component C), based on the total weight of the dispersion.

4. The dispersion according to claim 1, wherein the alkyl (meth)acrylates a1) comprises 0 to 20% by weight of C₁ to C₆ alkyl (meth)acrylates and 80 to 100% by weight of C₇ to C₃₀ alkyl (meth)acrylates, based on the total weight of alkyl (meth)acrylates a1).

5. The dispersion according to claim 1, wherein the alkyl (meth)acrylates a1) are selected from the list consisting of methyl (meth)acrylate, butyl (meth)acrylate, 2-ethylhexyl (meth)acrylate, decyl (meth)acrylate, isodecyl (meth)acrylate or a mixture thereof, preferably isodecyl (meth)acrylate.

6. The dispersion according to claim 1, wherein the hydroxy esters a2) are selected from the list consisting of 2-hydroxyethyl methacrylate, 1-methyl-2-hydroxyethyl methacrylate, 2-hydroxypropyl methacrylate or a mixture thereof, preferably 2-hydroxyethyl methacrylate.

7. The dispersion according to claim 1, wherein the monomers a) comprises from 60 to 99% by weight of monomers a1) and from 1 to 40% by weight of monomers a2), preferably 65 to 85% by weight of monomers a1) and from 15 to 35% by weight of monomers a2), based on the total weight of monomers a).

8. The dispersion according to claim 1, wherein in the graft copolymer A), the weight ratio of monomers a) grafted onto the ethylene-based copolymer is in a range from 1:1 to 9:1, preferably 2:1 to 6:1.

9. The dispersion according to claim 1, wherein the carrier medium C) is a mixture of isodecanol and diethylene glycol, preferably a mixture of from 55 to 75% by weight of isodecanol and from 25 to 45% by weight of diethylene glycol, based on the total weight of the carrier medium C).

10. The dispersion according to claim 1, wherein the dispersion comprises further additives D) selected from scale inhibitors, corrosion inhibitors, oxygen scavengers, biocides, emulsion breakers, antifoam agents, drag reducing agents, hydrate inhibitors, paraffin dispersants, pour point depressants, asphaltene control agents, or a mixture thereof.

11. Process for preparing the dispersion as defined in claim 1, wherein the process comprises the following steps:
i) providing a graft copolymer A),
ii) providing an ethylene-based copolymer B),
iii) mixing the graft copolymer A) with the ethylene-based copolymer B) in a carrier medium C).

12. Method for inhibiting wax deposition and reducing pour point, viscosity and yield stress of a crude oil by adding a dispersion as defined in claim 1 to the crude oil to form a crude oil composition.

13. The method of claim 12, wherein the method is used for reducing the pour point of a crude oil according to ASTM D5853.

14. A crude oil composition comprising a dispersion as defined in claim 1 and a crude oil, preferably wherein the amount of dispersion is 0.001 to 1% by weight, relative to the total weight of the crude oil composition.
